(19) United States
(12) Patent Application Publication
(10) Pub. No.: US 2025/0313460 A1
(43) Pub. Date: Oct. 9, 2025

(54) PROCESS AND DEVICE FOR GENERATING HYDROGEN FROM A HYDROCARBON USING A MULTI-PHASE METAL CATALYST

(71) Applicant: Ramot at Tel-Aviv University Ltd., Tel Aviv (IL)

(72) Inventors: Brian Ashley ROSEN, Tel Aviv (IL); Saurav SORCAR, Tel Aviv (IL)

(21) Appl. No.: 18/869,587

(22) PCT Filed: Jun. 1, 2023
(86) PCT No.: PCT/IL2023/050566

§ 371 Date: Nov. 26, 2024

Related U.S. Application Data
(60) Provisional application No. 63/351,012, filed on Jun. 10, 2022.

(51) Int. Cl. C01B 3/26

(52) U.S. Cl. CPC C01B 3/26; C01B 2203/0277; C01B 2203/1058; C01B 2203/1241; C01B 2203/1619; C01B 2203/1623; C01B 2203/1657

(57) ABSTRACT

A process for generating hydrogen from a hydrocarbon, such a process for natural gas pyrolysis, or for a hydrocarbon reforming. The process includes interacting the hydrocarbon with a metal catalyst containing a mixture of at least two metals under conditions at which a solid phase of at least one of the metals and a liquid phase of the metal catalyst are simultaneously present. A system is for carrying out the process.

### TECHNICAL FIELD

The present invention provides a process for generating hydrogen from a hydrocarbon, e.g., natural gas pyrolysis or a hydrocarbon reforming, by interacting said hydrocarbon with a metal catalyst comprising a mixture of at least two metals, under conditions at which a solid phase of at least one of said metals and a liquid phase of said metal catalyst are simultaneously present; and a system for carrying out said process.

### BACKGROUND ART

Natural gas is typically converted into hydrogen by methane steam reforming (Equation 1), which produces a mixture of hydrogen and carbon monoxide called synthesis gas.

$${CH}_{4} ( g ) + {H}_{2} O ( g ) ⇌ CO ( g ) + 3 {H}_{2} ( g ) {Δ H}^{0} = 206 kJ / mol \qquad ( 1 )$$

While synthesis gas can be used to manufacture clean-burning synthetic fuels via Fischer-Tropsch synthesis, the concern is that even synthetic fuels will eventually be burned and increase atmospheric CO₂ levels. The best technology for hydrogen production from natural gas (methane) is one where the carbon product is not used as a fuel but rather collected as solid carbon. This process is known as natural gas pyrolysis and is shown in Equation 2.

$$C {H}_{4} ( g ) ⇌ C ( s ) + 2 {H}_{2} ( g ) {Δ H}^{0} = 74 kJ / mol \qquad ( 2 )$$

Solid carbon could then be removed from the cycle completely and stored indefinitely by being incorporated as a solid into various materials or devices such as electrodes, concrete, asphalt, rubber and a wide variety of other carbon-containing materials. Furthermore, this technology can be implemented potentially via a low-cost commercial process in a one-step reaction. Natural gas pyrolysis occurs very quickly (i.e., low activation energy) on solid catalysts such as nickel (Ni), platinum (Pt) and palladium (Pd); however, the solid carbon (coke) accumulates on the metal surface and ultimately deactivates the catalyst, making the process unsustainable over the long term (Popov et al., 2013; Sun and Tang, 2000; Khan and Crynes, 1970; Serrano et al., 2009). Therefore, pyrolysis reactors which utilize solid catalysts would need to frequently halt the pyrolysis process to either replace or clean the solid catalyst.

A novel solution that has been tried for natural gas pyrolysis that does not deactivate the catalyst is to use a liquid molten metal catalyst (Upham et al., 2017; Kang et al., 2020; Catalan and Rezaei, 2020). If natural gas is bubbled through a molten metal, carbon will form on the edge of the bubble at the gas-metal interface as the bubble rises through the melt. Ultimately, this carbon will collect on the top of the molten metal since the density of carbon is significantly lower than that of the liquid metal. Furthermore, if carbon saturates the melt through diffusion, the supersaturated carbon would also rise to the top of the melt (Palmer et al., 2019). The force of the flowing gas could then be used to push the solid carbon out of the reactor, although alternative mechanisms for continuous removal of the carbon are possible as well. The advantage of using a molten metal catalyst is that natural gas which is bubbled through the reactor is always in contact with fresh molten catalyst, promoting the long-term stability of the reactor and ideally a constant production of gas consisting of hydrogen and only trace amounts of CO or CO₂ (carbon floats to the top of the molten metal while the hydrogen escapes as a gas; therefore, the accumulation of carbon does not directly harm the molten metal catalyst and the reactor can be built for continuous use, FIG. 1). This reaction may enable the wide-scale distribution of “blue” hydrogen, rather than the distribution of natural gas. Of significance is that the hydrogen production here would not entail the significant production of carbon-based gasses such as CO and CO₂, which are detrimental to our environment, and will likely come with an economic tax. Indeed, every ton of hydrogen produced via steam reforming (Equation 1) produces 5 tons of CO₂ (U.E.P.A. Office of Air and Radiation, Proposed Rule for Mandatory Reporting of Greenhouse Gasses 2008).

WO 2019/099795 teaches that the reaction rate of hydrocarbon pyrolysis can be increased to produce solid carbon and hydrogen by using molten materials which have catalytic functionality to increase the rate of reaction and physical properties that facilitate the formation and contamination-free separation of the solid carbon discloses. This publication further discloses a multiphase reaction method comprising (i) contacting one or more gas phase reactants with a solid phase disposed within a liquid phase in a reactor, wherein the one or more gas phase reactants comprise a hydrocarbon; the liquid phase comprises a molten salt; and the solid phase comprises a solid phase catalyst; and (ii) producing one or more reaction products in response to contacting the one or more gas phase reactants with the solid phase, wherein the reaction products comprise solid carbon and hydrogen.

Data collected at the University of California Santa-Barbra estimates that a 600 m³ molten metal reactor could produce 200 kilotons of H₂ per year operating at 10 atm with 95% methane conversion (Upham et al., 2017). Having such a reactor would not only be a grand technological milestone on the international stage but would also further energy independence while simultaneously preventing the release of CO₂ into the atmosphere. There are techno-economic studies that show that natural gas pyrolysis can be economically competitive with steam reforming (Equation 1), particularly if the carbon produced in the reaction is valuable and if various governments worldwide begin to implement a carbon tax for CO₂ emissions (Steinberg 1999; Parkinson et al., 2017; Muradov and Veziroğlu, 2005; Muradov 2017).

Metals that are active catalysts for methane decomposition (Pt, Pd, Ni) have been dissolved in inactive and lower-melting temperature metals such as indium (In), bismuth (Bi), gallium (Ga), tin (Sn), and lead (Pb). Although the meting point of the active metals is high, the binary equilibrium phase-diagrams of such metals show that their mixtures can be completely molten at significantly lower temperatures. Initial research into such reactors has given rise to several initial conclusions including (1) the “inactive” metal used to lower the melting point of the mixture often shows some activity; (2) the activity increases with the amount of active metal; (3) the activity depends on the nature of both the active and inactive metal; (4) Ni is more active than Pt for hydrogen production from methane within the molten liquid phase despite the fact that Ni and Pt have approximately the same activity in the solid phase; and (5) molten metal mixtures such as copper (Cu) and bismuth (Bi) show activity despite the fact that both metals on their own are inactive for methane pyrolysis (Upham et al., 2017; Palmer et al., 2019).

In addition to molten metals, methane pyrolysis has also been investigated using molten salts such as MnCl₂—KCl (Kang et al., 2019). Similar to the molten metals above, it is often the case that MnCl₂ and KCl themselves are poor catalysts, but their mixture makes a good catalyst. Such an effect can be related to charge transfer phenomenon within the melt (Bader charge analysis) or the complexation of ions into different configurations when a second component is added.

Prior to the idea of performing natural gas pyrolysis in a molten reactor, solid catalysts were extensively tested, and still have some interest today. The addition of promoters such as K₂CO₃ to solid-phase catalysts can help keep the reactor clean by converting carbon stuck to the catalyst surface into CO and CO₂ (Zhang et al., 2018). While it is not ideal to have CO and CO₂ mixed in with the hydrogen gas, most of the carbon still goes to the solid phase, and this configuration is still being considered and studied in parallel to the molten metal option.

The figures-of-merit for this reaction include (1) methane conversion; (2) hydrogen selectivity; (3) activation energy; (4) rate of solid carbon accumulation per volume of molten metal; and (5) type of solid carbon produced. Experimentally, molten reactors for methane pyrolysis typically operate between 35-85% conversion of methane and at temperatures between 800° C. and 1050° C. The conversion is dependent not only on intrinsic variables such as the activation energy as determined by the catalyst used, but also on extrinsic variables such as temperature, bubble size, depth of melt, and the partial pressure of methane. One of the key advantages of methane pyrolysis is that the selectivity towards the formation of H₂ is very high, typically above 85%. This is due to the fact that there are only a limited number of paths for oxygen to enter the system and form CO and CO₂ (moisture, air, oxides). The type of carbon formed is often graphitic, but multi-walled carbon nanotubes can also be produced. Both types of carbons have commercial value as they are incorporated into a variety of materials for electronics, transportation, and infrastructure.

### SUMMARY OF INVENTION

In one aspect, disclosed herein is a process for generating hydrogen from a hydrocarbon, e.g., a process for natural gas pyrolysis in which hydrogen and carbon are generated; or for a hydrocarbon (e.g., methane) reforming in which hydrogen and either carbon dioxide or carbon monoxide are generated, said process comprising interacting said hydrocarbon, optionally together with carbon dioxide and/or steam, with a metal catalyst comprising a mixture of at least two metals, under conditions, including temperature, at which a solid phase of at least one of said metals and a liquid phase of said metal catalyst (molten metal) are simultaneously present, to thereby obtain said hydrogen.

More particularly, disclosed herein is a process as defined above, wherein both the release rate of the hydrogen generated and the temperature, during said process, are monitored, and said temperature is increased or decreased, when necessary, within a range at which both said solid phase and said liquid phase are simultaneously present, to thereby increase or decrease the ratio between said liquid phase and said solid phase accordingly, and consequently increase the amount of hydrogen generated.

Monitoring of the hydrogen release rate and temperature during said process may each independently be carried out either occasionally or continuously, but preferably continuously, so as to make sure that the functioning level of the catalyst and consequently the hydrogen release rate, at each point in time, are optimized. Specifically, in case the hydrogen release rate monitored is below a predefined level, indicating carbon accumulation on said solid phase and consequently a functioning level of said catalyst that is lower than a predefined level, said temperature is increased thereby releasing the carbon accumulated on said solid phase and consequently increasing the functioning level of said catalyst and the hydrogen release rate. Alternatively, in case the temperature monitored is approaching, i.e., about to reach, a predefined level at which said liquid phase only is present (i.e., no solid phase is present), said temperature is decreased thereby forming new solid phase and consequently increasing the functioning level of said catalyst and the hydrogen release rate.

In certain embodiments, said metal catalyst comprises a mixture of nickel (Ni) and tin (Sn), and exists both as solid Ni₃Sn₂ and as molten Ni and Sn mixture; and said process is carried out at a temperature of, e.g., from about 900° C. to about 1300° C. In other embodiments, said metal catalyst comprises a mixture of Ni and bismuth (Bi), and exists both as solid Ni and as molten Ni and Bi mixture; and said process is carried out at a temperature of, e.g., from about 850° C. to about 1600° C.

The process disclosed herein may be carried out, e.g., in a system comprising:
(a) a reaction chamber comprising an inlet for introducing said hydrocarbon, an outlet for releasing said hydrogen, at least one temperature sensor, at least one heater, and optionally a hydrogen sensor located at said outlet and/or an outlet for removing solid carbon obtained during said process; and
(b) means for receiving data from said at least one temperature sensor; and said hydrogen sensor, when present,
wherein activation and deactivation of said at least one heater is determined based on said received data. Said means for receiving data may be, e.g., a computing system comprising a processor and a memory, and configured to receive data from: (1) said at least one temperature sensor and analyze same in real-time to determine the temperature within the reaction chamber and activate/deactivate said at least one heater accordingly; and (2) said hydrogen sensor, when present, and analyze same in real-time to determine the release rate of the hydrogen generated and activate said at least one heater in case said release rate is below a predetermined level.

According to the present invention, said reaction chamber may comprise more than one temperature sensor each located at a different location within said reaction chamber, and more than one heater each located at a different location within said reaction chamber, enabling to maintain, during said process, a different temperature range in each one of said locations. In certain embodiments, the temperature in the lower part of said reaction chamber, during said process, is higher than the temperature in the upper part of said reaction chamber, such that the percent of said metal catalyst existing in its liquid form in the lower part of said reaction chamber is higher than that in the upper part of said reaction chamber, e.g., higher than 50, 60, 70, 80, 90, 95, or 99% of said metal catalyst. In other embodiments, the temperature in the upper part of said reaction chamber, during said process, is higher than the temperature in the lower part of said reaction chamber, such that the percent of said metal catalyst existing in its liquid form in the upper part of said reaction chamber is higher than that in the lower part of said reaction chamber, e.g., higher than 50, 60, 70, 80, 90, 95, or 99% of said metal catalyst.

In another aspect, disclosed herein is thus a system for generating hydrogen from a hydrocarbon comprising:
(a) a reaction chamber comprising an inlet for introducing said hydrocarbon, an outlet for releasing said hydrogen, at least one temperature sensor, at least one heater, and optionally a hydrogen sensor located at said outlet and/or an outlet for removing solid carbon obtained during said process; and
(b) means for receiving data from said at least one temperature sensor; and said hydrogen sensor, when present,
wherein activation and deactivation of said at least one heater is determined based on said received data.

### BRIEF DESCRIPTION OF DRAWINGS

FIG. 1 shows schematic of a pyrolysis reactor where methane is bubbled through multi-phase molten metal producing only solid carbon and hydrogen.

FIGS. 2A-2D show dependence of activation energy on location in the binary phase diagram. 2A shows Arrhenius plot for calculating the activation energy for solid Ni. 2B shows Arrhenius plot for calculating the activation energy for solid Ni₃Sn₂. 2C shows selected region of the binary Sn—Ni phase diagram showing the liquidus point at 1000° C. (point 1), the operational condition for 2-phase pyrolysis (point 2), and the operational condition for catalyst recovery (point 3) modified and re-used with permission from Schmetterer et al. (2007). 2D shows Arrhenius plot for calculating the activation energy for methane pyrolysis in a molten reactor at the one-phase liquidus line (point 1) and the 2-phase region (point 2) of the binary Sn—Ni phase diagram.

FIG. 3 shows equilibrium phase diagrams for the Ni—Bi.

FIGS. 4A-4G show the formation of Ni₃Sn₂ in the multiphase reactor and the separatable carbon product. 4A shows operational multiphase Sn—Ni reactor operating in the 2-phase region (point 2 from FIG. 2C) temporarily raised from the muffle furnace to reveal the strata of the multiphase melt and the region of carbon accumulation above the melt. 4B shows the spatial distribution of the initial Ni₃Sn₂ (dark) is seen as a ring at surface of the melt adjacent to the reactor wall as the reactor is cooled 33% of the way between points 3 and 2 from FIG. 2C. 4C shows the spatial distribution of the initial Ni₃Sn₂ (dark) is seen as a disc near the surface of the melt pushing its way down into the volume of the as the reactor is cooled 66% of the way between points 3 and 2 from FIG. 2C. 4D shows light microscope micrograph showing the Ni₃Sn₂ particles (circular) in the reactor after it was flash quenched from point 2 down to room temperature, mounted in epoxy and polished. 4E shows cross section of the recovered Sn—Ni slug after operation at point 2 for 10 hours showing carbon accumulation on a Ni₃Sn₂ phase in the upper strata at the upper outside part of the melt. 4F shows graphitic carbon removed from the top of the reactor after operation at point 2 for 10 h. 4G shows Raman spectra of the carbon recovered from FIG. 4F.

FIG. 5 shows a light microscope image of quenched metal slug operating at liquidus line.

FIG. 6 shows EDS mapping data of grinded/polished metal slug recovered by rapid quenching of 2 phase molten metal reactor.

FIG. 7 shows digital image of the metal chunk after operation at point 2 for 10 hours obtained by quenching.

FIG. 8 shows cross-sectional digital image of metal chunk after operation at point 2 for 10 hours obtained by quenching used for SEM-EDS analysis. The SEM-EDS was conducted for the “outside and inside dark spot” as shown above.

FIG. 9 shows SEM-mapping analysis of “rectangle region”, i.e., “outside dark spot” of the quenched metal chunk shown in FIG. 8.

FIG. 10 shows SEM-mapping analysis of “rectangle region”, i.e., “inside dark spot of the quenched metal chunk shown in FIG. 8.

### DETAILED DESCRIPTION

Exemplified herein is a process for methane pyrolysis, which comprises interacting said methane with a molten metal catalyst, more specifically Si—Ni or Ni—Bi catalyst, and takes place in a region of the equilibrium phase diagram of the binary Sn—Ni or Ni—Bi phase, where at least one solid phase is present in equilibrium together with the molten metal. As shown, methane pyrolysis is carried out in a reactor having at least two phases inside of it, wherein it is possible to exploit the low activation energy provided by the solid phase with the natural carbon separation provided by the melt. In the event that carbon accumulation on the solid phase becomes severe, the system needs only to be heated above the melting point of the solid phase, thereby releasing the carbon to the top of the melt. The system temperature could then be lowered back into the two-phase region to reform fresh solid catalyst.

In one aspect, the present invention thus provides a process, e.g., a continuous process, for generating hydrogen from a hydrocarbon, said process comprising interacting said hydrocarbon, optionally together with carbon dioxide and/or steam, with a metal catalyst comprising a mixture of at least two metals, e.g., two, three, four, or more, under conditions at which a solid phase of at least one of said metals and a liquid phase of said metal catalyst (molten metal) are simultaneously present, optionally in equilibrium, to thereby obtain said hydrogen.

The term “conditions” as used herein refers to the set of operating conditions for conducting the process disclosed, and particularly to the temperature at which said process is carried out.

The metal catalyst utilized according to the process of the present invention is a mixture of at least two, e.g., two or three, metals, and under the conditions, e.g., temperature, at which said process is carried out, at least one solid phase of said metal catalyst and a liquid phase of said metal catalyst are simultaneously present at equilibrium. In certain embodiments, said solid phase comprises said mixture, i.e., an alloy of said at least two metals, and said liquid phase is molten of said at least two metals. In other embodiments, said solid phase comprises some but not all of the metals composing said mixture, e.g., only one of the two metals composing said mixture, and said liquid phase is molten of said at least two metals. According to the invention, and as shown in the experimental section herein, the conditions at which said process is performed may be changed during the process, more specifically, the temperature may be alternatively increased or decreased within a particular range at which both said solid phase and said liquid phase are simultaneously present in equilibrium, to thereby increase or decrease the ratio between said liquid phase and said solid phase, accordingly, and consequently improve the function of said metal catalyst to thereby increase the amount of hydrogen generated.

Thus, more particularly disclosed herein is a process for generating hydrogen from a hydrocarbon as defined above, wherein both the release rate of the hydrogen generated and the temperature, during said process, are monitored, and said temperature is increased or decreased, when necessary, within a range at which both said solid phase and said liquid phase are present, to thereby increase or decrease the ratio between said liquid phase and said solid phase accordingly, and consequently increase the amount of hydrogen generated. Specifically, in case the hydrogen release rate monitored is below a predefined level, indicating carbon accumulation on said solid phase and consequently a functioning level of said catalyst that is lower than a predefined level, said temperature is increased thereby releasing the carbon accumulated on said solid phase to the top of the melt and consequently increasing the functioning level of said catalyst and the hydrogen release rate. Alternatively, in case the temperature monitored is about to reach a predefined level at which said liquid phase only is present, said temperature is decreased thereby forming fresh solid phase (free of carbon accumulated thereon) and consequently increasing the functioning level of said catalyst and the hydrogen release rate.

The term “predefined level” as used herein with respect to the hydrogen release rate during the process of the invention refers to an amount of hydrogen that should be generated by the process and released over a particular period of time, depending on the specific metal catalyst used (i.e., the specific metal mixture composing said catalyst and the exact composition thereof) and the amount thereof, the volume of the system in which said process is carried out, and the amount of hydrocarbon introduced into the process over said period of time.

Similarly, the term “predefined level” as used herein with respect to the functioning level of said catalyst refers to a functioning level of said catalyst, at which a predefined level of hydrogen is released from the process over a particular period of time, taking into consideration the volume of the system in which said process is carried out and the amount of hydrocarbon introduced into the process over said period of time.

In certain embodiments, the metal catalyst utilized according to the process disclosed herein comprises a mixture of a first metal selected from platinum (Pt), palladium (Pd), nickel (Ni), copper (Cu), and a mixture thereof; and a second metal selected from indium (In), bismuth (Bi), gallium (Ga), tin (Sn), lead (Pb), and a mixture thereof. According to the invention, while the first metal (or combination of metals) is the catalyst per se, the second metal (or combination of metals) is aimed at lowering the melting point of the metal mixture but could also contribute to the catalytic activity of said catalyst. The weight ratio between the metal(s) acting as the catalyst per se and the metal(s) aimed at lowering the melting point of the metal mixture may be any ratio such that the melting point of said metal mixture is lowered compared to that of the metal(s) acting as the catalyst per se without limiting the catalytic activity.

In certain embodiments, the process of the present invention is carried out within a temperature range at which the percent of said metal catalyst existing in its solid form is from 1% to 99%, e.g., from about 5% to about 95%, from about 10% to about 90%, from about 15% to about 85%, from about 20% to about 80%, from about 25% to about 75%, from about 30% to about 70%, from about 35% to about 65%, from about 40% to about 60%, or from about 45% to about 55%, but preferably from about 5% to about 50%, e.g., about 5%, about 10%, about 15%, about 20%, about 25%, about 30%, about 35%, about 40%, about 45%, or about 50%.

In certain embodiments, the metal catalyst utilized according to the process disclosed herein, according to any one of the embodiments above, comprises an alloy of Ni and Sn; and exists both as solid Ni₃Sn₂, e.g., in the form of Ni₃Sn₂ particles, and as molten Ni and Sn mixture. A process utilizing such a metal catalyst may be carried out at a temperature range of from about 900° C. to about 1300° C., e.g., from about 900° C. and up to about 1000° C., 1050° C., 1100° C., 1150° C., 1200° C., or 1250° C.

In certain embodiments, the metal catalyst utilized according to the process disclosed herein, according to any one of the embodiments above, comprises an alloy of Ni and Bi; and exists both as solid Ni, e.g., in the form of Ni particles, and as molten Ni and Bi mixture. A process utilizing such a metal catalyst may be carried out at a temperature range of from about 850° C. to about 1600° C., e.g., from about 850° C. and up to about 1000° C., 1050° C., 1100° C., 1150° C., 1200° C., 1250° C., 1300° C., 1350° C., 1400° C., 1450° C., 1500° C., or 1550° C.

In certain embodiments, the process of the present invention, according to any one of the embodiments above, is carried out in the presence of an inert ceramic material. Non-limiting examples of inert ceramic materials include inorganic oxides such as silica, alumina, ceria, and lanthana. According to the invention, the inert ceramic material serves as a source of nucleation points on which the solid phase of the metal catalyst crystalizes, i.e., said solid phase is formed on the inert ceramic material rather than on other interfaces that could serve as a nucleation point, such as the walls of the reactor in which said process takes place, e.g., at the top of the reactor.

In certain embodiments, the process disclosed herein, according to any one of the embodiments above, is for pyrolysis of a hydrocarbon or a mixture thereof, e.g., a natural gas, and comprises interacting said hydrocarbon or mixture thereof, e.g., natural gas, with said metal catalyst to thereby obtain said hydrogen and solid carbon.

The term “natural gas” commonly denotes a naturally occurring mixture of gaseous hydrocarbons consisting primarily of methane, i.e., comprising from about 50% and up to 60%, 70%, 80%, 90%, 95%, 96%, 97%, 98%, 99%, or more, by weight of said mixture, methane, as well as smaller amounts of other various higher alkanes (depending on the source of said natural gas). In certain embodiments, said natural gas either consists or essentially consists of methane, i.e., comprises either pure or almost pure methane, respectively.

In certain particular embodiments, the process disclosed herein is for natural gas pyrolysis; the metal catalyst utilized comprises an alloy of Ni and Sn, and exists both as solid Ni₃Sn₂, e.g., in the form of Ni₃Sn₂ particles, and as molten Ni and Sn mixture; and said process is carried out at a temperature range of from about 900° C. to about 1300° C., e.g., from about 900° C. and up to about 1000° C., 1050° C., 1100° C., 1150° C., 1200° C., or 1250° C.

In other particular embodiments, the process disclosed herein is for natural gas pyrolysis; the metal catalyst utilized comprises an alloy of Ni and Bi, and exists both as solid Ni, e.g., in the form of Ni particles, and as molten Ni and Sn mixture; and said process is carried out at a temperature range of from about 850° C. to about 1600° C., from about 850° C. and up to about 1000° C., 1050° C., 1100° C., 1150° C., 1200° C., 1250° C., 1300° C., 1350° C., 1400° C., 14500° C., 1500° C., or 1550° C.

In certain embodiments, the process disclosed herein, according to any one of the embodiments above, is for reforming of said hydrocarbon, i.e., for converting said hydrocarbon to hydrogen and either carbon dioxide or carbon monoxide, and comprises (i) interacting said hydrocarbon together with carbon dioxide, with said metal catalyst to thereby obtain said hydrogen and carbon monoxide; or (ii) interacting said hydrocarbon together with steam, with said metal catalyst to thereby obtain said hydrogen and carbon dioxide; or (iii) interacting said hydrocarbon together with both carbon dioxide and steam, with said metal catalyst to thereby obtain said hydrogen and carbon monoxide. In particular such embodiments, said hydrocarbon is methane or consists primarily of methane.

In some particular such embodiments, the process disclosed is for dry reforming of said hydrocarbon, e.g., methane, and comprises interacting said hydrocarbon and carbon dioxide, with said metal catalyst to thereby obtain said hydrogen and carbon monoxide.

In other particular such embodiments, the process disclosed is for steam reforming of said hydrocarbon, e.g., methane, and comprises interacting said hydrocarbon and steam, with said metal catalyst to thereby obtain said hydrogen and carbon dioxide.

In further particular such embodiments, the process disclosed is for mixed reforming of said hydrocarbon, e.g., methane, and comprises interacting said hydrocarbon and both carbon dioxide and steam, with said metal catalyst to thereby obtain said hydrogen and carbon monoxide.

In certain embodiments, the process of the present invention, according to any one of the embodiments above, is carried out in a system comprising (a) a reaction chamber comprising an inlet for introducing the hydrocarbon, an outlet for releasing the hydrogen, at least one temperature sensor, at least one heater, and optionally a hydrogen sensor located at said outlet; and (b) means for receiving (optionally continuously) data from (1) said at least one temperature sensor; and (2) said hydrogen sensor, when present, wherein activation and deactivation of said at least one heater is determined based on said received data.

The data received from the at least one temperature sensor is analyzed in real-time, and is used for determining whether the temperature within the reaction chamber should be maintained or altered (i.e., increased or reduced), and for activating/deactivating said at least one heater accordingly. For example, in case the temperature inside the reaction chamber is lower than a predefined level at which both a solid phase of at least one of the metals composing said metal catalyst and a liquid phase of said metal catalyst (molten metal) are simultaneously present, said at least one heater is activated until the temperature inside the reaction chamber reaches said predefined level and within the range required, i.e., determined in the first place. Likewise, in case the temperature inside the reaction chamber is higher than said predefined level and approaching a point wherein all the metal catalyst will be in a liquid form, said at least one heater is deactivated until the temperature inside the reaction chamber has dropped and is once again within the range required.

Similarly, the data received from the hydrogen sensor, when present, is analyzed in real-time, and is used for determining the release rate of the hydrogen generated, i.e., the efficacy of the process carried out at any time point thereof. For example, in case the hydrogen release rate is below a predefined level indicating carbon accumulation on the solid phase of said metal catalyst and consequently a catalyst functioning that is lower than a predefined level (or optimum), said at least one heater is activated so as to increase the temperature inside the reaction chamber and consequently the ratio between said liquid phase and said solid phase, improving the function of said metal catalyst and thereby increasing the amount of hydrogen generated and released.

In particular embodiments, the process of the present invention is carried out in a system as defined hereinabove, wherein the reaction chamber further comprises an outlet for removing solid carbon obtained during said process. Such outlet may be equipped with either a mechanical mechanism such as a screw, arm, shovel, and scrapper, or a gas-phase mechanism such as suction and forced gas flow, for removal of the solid carbon.

In particular embodiments, the process of the present invention is carried out in a system as defined hereinabove, optionally further comprising an outlet for removing solid carbon obtained during said process, wherein said means for receiving data is a computing system comprising a processor and a memory, and said computing system is configured to receive (optionally continuously) data from: (1) said at least one temperature sensor and analyze same in real-time to determine the temperature within the reaction chamber and activate/deactivate said at least one heater accordingly; and (2) said hydrogen sensor, when present, and analyze same in real-time to determine the release rate of the hydrogen generated and activate said at least one heater in case said release rate is below a predetermined level.

In particular embodiments, the process of the present invention is carried out in a system as defined in any one of the embodiments hereinabove, wherein the reaction chamber comprises more than one, e.g., two, three, or more, temperature sensor each located at a different location within said reaction chamber, e.g., at least one temperature sensor is located at the lower part of said chamber and at least one temperature sensor is located at the upper part of said chamber, and more than one, e.g., two, three, or more, heater each located at a different location within said reaction chamber, e.g., at least one heater is located at the lower part of said chamber and at least one heater is located at the upper part of said chamber, enabling to maintain, during said process, a different temperature range in each one of said locations.

In some particular configurations of such a process, the temperature (or average temperature) maintained in the lower part of said reaction chamber, during said process, is higher than the temperature (or average temperature) maintained in the upper part of said reaction chamber, such that the percent of the metal catalyst existing in its liquid form in the lower part of said reaction chamber is higher than that in the upper part of said reaction chamber. In a particular example of such a configuration, the temperature (or average temperature) maintained in the lower part of the reaction chamber, during the process, is sufficiently high such that the metal catalyst in the lower part of said reaction chamber exists in its liquid form only.

In other particular configurations of such a process, the temperature (or average temperature) maintained in the upper part of said reaction chamber, during said process, is higher than the temperature (or average temperature) maintained in the lower part of said reaction chamber, such that the percent of the metal catalyst existing in its liquid form in the upper part of said reaction chamber is higher than that in the lower part of said reaction chamber. In a particular example of such a configuration, the temperature (or average temperature) maintained in the upper part of the reaction chamber, during the process, is sufficiently high such that the metal catalyst in the upper part of said reaction chamber exists in its liquid form only.

In another aspect, the present invention provides a system for carrying out the process disclosed herein, i.e., generating hydrogen from a hydrocarbon, said system comprising: (a) a reaction chamber (i.e., reactor) comprising an inlet for introducing said hydrocarbon, an outlet for releasing said hydrogen, at least one temperature sensor, at least one heater, and optionally a hydrogen sensor located at said outlet; and (b) means for receiving (optionally continuously) data from: (1) said at least one temperature sensor; and (2) said optional hydrogen sensor, wherein activation and deactivation of said at least one heater is determined based on said received data.

In certain embodiments, the reaction chamber comprised within the system disclosed herein further comprises an outlet for removing solid carbon obtained during said process.

In certain embodiments, the reaction chamber comprised within the system disclosed herein does not comprise a hydrogen sensor. In particular such embodiments, said means for receiving data is a computing system comprising a processor and a memory that is configured to receive (optionally continuously) said data from said at least one temperature sensor, and analyze same in real-time to determine the temperature within the reaction chamber and automatically activate/deactivate said at least one heater accordingly.

In other embodiments, the reaction chamber comprised within the system disclosed herein comprises a hydrogen sensor. In particular such embodiments, said means for receiving data is a computing system comprising a processor and a memory that is configured to receive (optionally continuously) said data from both said at least one temperature sensor and said hydrogen sensor, and analyze same in real-time to determine both: (a) the temperature within the reaction chamber and automatically activate/deactivate said at least one heater accordingly; and (b) the release rate of the hydrogen generated and activate said at least one heater in case said release rate is below a predetermined level.

In certain embodiments, the computing system comprised within the system disclosed herein is either an integral part of said reaction chamber or wirely connected thereto, and said computing system optionally comprises a display.

In other embodiments, the computing system comprised within the system disclosed herein is a remote computing system that is wirelessly associated with said reaction chamber, such as a laptop, a tablet or a smartphone. The computing system is equipped with a dedicated program/application designed to receive data from said at least one temperature sensor and said hydrogen sensor, analyze same, provide outputs according to demand, such as graphs indicating the productivity of the system, amount of hydrogen produced per time-period, such as per hour/day/week/month, etc., and store all for future use. This will assist in monitoring the system's efficiency. In certain embodiments, the computing system can provide an alert when hydrogen production reduces below a predefined level, and/or when a malfunction is detected in the reactor, in one of the sensors and/or in the heater.

In specific embodiments, the system disclosed herein further comprises a wireless communication means, such as Wi-Fi or Bluetooth, using any known wireless technology, for enabling the reactor and the at least one temperature sensor and hydrogen sensor, when present, to communicate with said remote computing system and/or another external device that is required for, e.g., measuring another parameter within the system or an alarm. In alternative specific embodiments, the at least one temperature sensor and the hydrogen sensor, when present, are wireless sensors, i.e., can transmit data wirelessly, such as, but not limited to, Bluetooth sensors.

In a particular such aspect, the present invention thus provides a system for carrying out the process disclosed herein, i.e., generating hydrogen from a hydrocarbon, said system comprising: (a) a reaction chamber comprising an inlet for introducing said hydrocarbon, an outlet for releasing said hydrogen, at least one temperature sensor, at least one heater, and optionally a hydrogen sensor located at said outlet; and (b) a computing system comprising a processor and a memory, wherein said computing system is configured to receive (optionally continuously) data from: (1) said at least one temperature sensor and analyze same in real-time to determine the temperature within the reaction chamber and activate/deactivate said at least one heater accordingly; and (2) said hydrogen sensor, when present, and analyze same in real-time to determine the release rate of the hydrogen generated and activate said at least one heater in case said release rate is below a predetermined level.

For purposes of clarity, and in no way limiting the scope of the teachings, unless otherwise indicated, all numbers expressing percentages or temperatures, and other numerical values recited herein, should be interpreted as being preceded in all instances by the term “about”, regardless of whether “about” is explicitly prepended to the numerical value. Accordingly, unless indicated to the contrary, the numerical parameters set forth in this specification are approximations that may vary by up to plus or minus 10% depending upon the desired properties to be obtained by the present invention.

The invention will now be illustrated by the following non-limiting Examples.

### Examples

### Study 1. Methane Pyrolysis Using a Multi-Phase Molten Metal Reactor

### Materials and Methods

Metal powders of Ni (10 microns) and Sn (63 micron) were procured from Goodfellow Cambridge Limited (England). A calculated amount of mixed metal powders was held and melted in a quartz tube of 32 cm and 1-inch diameter. Metal powders were reduced by a 5% H₂+N₂ mixture to 1000° C., which flowed through a quartz tube with a 0.25-inch diameter. The metal powder inside the quartz tube reached a height of 7 cm. At elevated temperatures, the molten metal had a height of 3 cm, the region which was held at isothermal conditions. The depth of the quartz tube inside the muffle furnace (Kittec) was fixed to 14 cm. Mass flow controllers (Alicat Scientific Instruments) were used to deliver hydrogen, methane, and nitrogen. Gas chromatography (SRI 8610C) was used to analyse the products. Scanning electron microscopy (SEM) (Quanta 200 FEG ESEM) and Raman analysis (Horiba, LabRAM HR Evolution, excitation wavelength 532 nm) were utilized for the investigation of metal slug and carbon obtained during the pyrolysis experiment, respectively. The obtained metal slug was mounted in a mixture of epoxy (12.5 g) and hardener (1.5 g) until it hardened for 24 h. This was followed by grinding (Struers, diamond polish 3 microns) and polish (Struers, LabPol-1). The ground/polished metal slug was investigated using an optical microscope (Eclipse LV150N, Nikon), energy dispersive X-ray spectroscopy (EDX), and SEM.

### The Novel Reactor

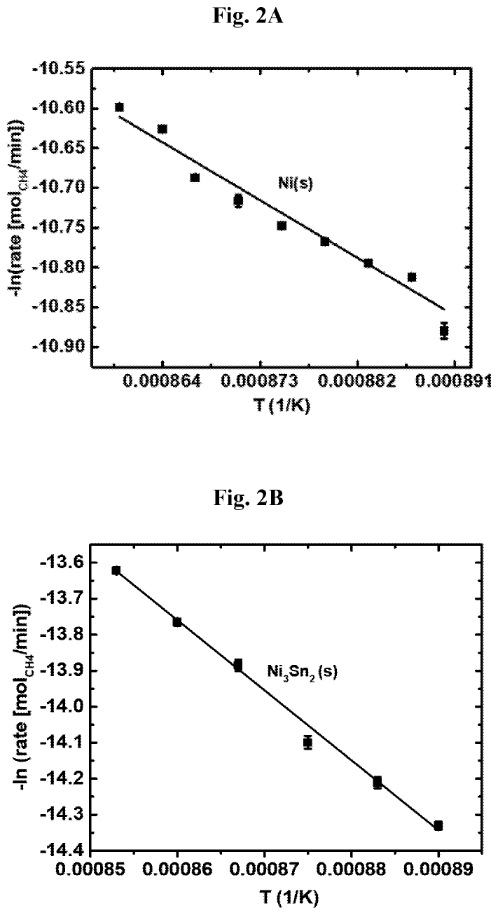

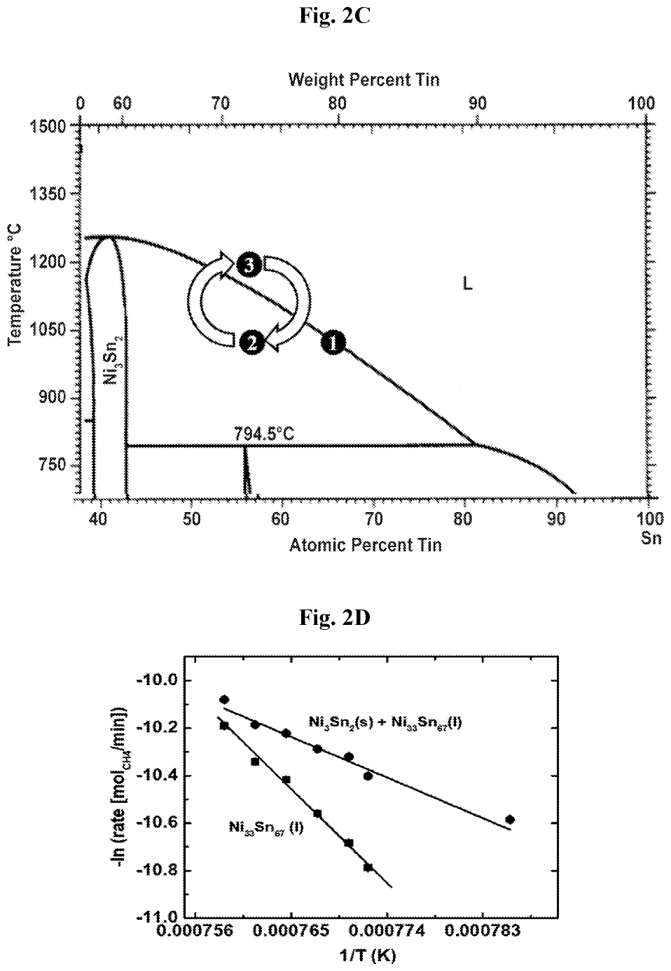

For conducting methane pyrolysis, we generated a multi-phase reactor for a Sn—Ni melt operating in the 2-phase region of the binary Sn—Ni phase diagram. FIG. 2C shows a portion of the Ni—Sn phase diagram with the three characteristic points used in this study. Point 1 is the point on the liquidus line at 1000° C. (33 at % Ni, 67 at % Sn); here, only the liquid Sn—Ni alloy exists. Point 2 falls within the 2-phase region at 1000° C. and has an overall composition of 42 at % Ni and 58 at % Sn. At this point, the solid phase is Ni₃Sn₂, and the liquid phase is the Sn—Ni liquid alloy. The point of creating these solid phases is to take advantage of the low activation energy typically observed with solid catalysts compared to the liquid.

Importantly, since point 1 falls on the liquidus line, the composition of the Sn—Ni liquid alloy at point 2 is identical to that of point 1. Tie-line analysis shows that at point 2, the fraction of Ni₃Sn₂ in the reactor is 39 wt %.

Furthermore, in the case where carbon does begin to accumulate on these solid particles, the reactor need only be heated up above the melting point of the mixture (point 3 in FIG. 2C) and the entire reactor will return to a complete molten state where the carbon can be separated. Fresh solids free of coke could then be reformed by cooling the reactor back down to the multi-phase region (point 1 in FIG. 2C). This mechanism for regenerating solids free of coke by a quick temperature swing is far easier than oxidation methods or catalyst swapping.

In another configuration, the multi-phase molten reactor can have both a “hot” and a “cold” zone. The hot zone on the bottom will be completely molten, while the cooler zone on top will have both liquid metal and solid particles together in equilibrium. The formed phases in the top would sink (if not attached to the walls, because they are denser) into the hot zone and re-melt, forming a “source” and “sink” for particles. All the while, methane bubbles will rise through both zones and interact with both the liquid and solid particles as it rises.

This reactor configuration provides the benefits of using a solid catalyst (lower activation energy), while at the same time, allowing that catalyst to eventually melt again and separate from the carbon to become refreshed.

In yet another configuration, an inert ceramic phase (separated from the multiphase metal catalyst) could be inserted into the reactor to form nucleation points and control the location of the solid formation. Without such an inert ceramic phase, the solid phases would begin to crystalize on the walls near the top of the reactor, which is not the most efficient location. Examples of such inert ceramic phases include, but are not limited to, silica, alumina, ceria, and lanthana.

### Reactor Chemistry Example 1: Ni—Sn

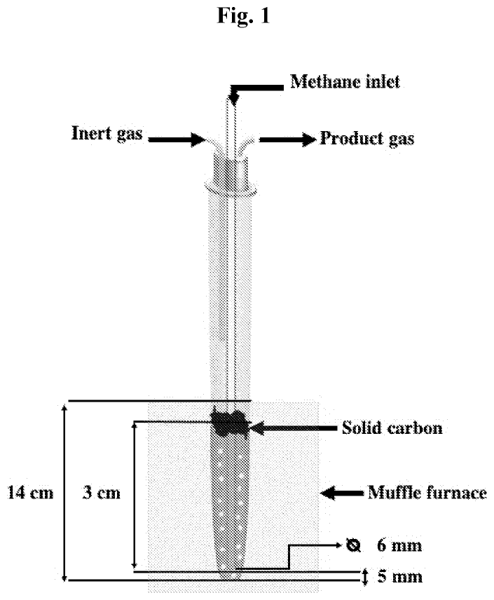

FIG. 2D shows a direct comparison between the activation energy measured using the liquid Sn—Ni catalyst (liquidus line, point 1) and the 2-phase Sn—Ni(liq.)/Ni₃Sn₂(s) catalyst (point 2). This was achieved by flowing 5 vol % CH₄ in N₂ (200 standard cubic centimeters per minute (sccm)) through the central 6 mm quartz tube of the molten reactor (see schematic, FIG. 1). Importantly, the conversion of CH₄ was well below 5%, ensuring that the activation energy was calculated entirely within the kinetic regime. It is to be noted that if any part of the molten reactor were held at point 2, this lower temperature where both solid Ni₃Sn₂ and molten Ni—Sn components existed together, the activation energy could be reduced via the use of the solid Ni₃Sn₂ phase.

Furthermore, if over time carbon does accumulate on the solid Ni₃Sn₂ phase, one need only heat up the reactor by a small margin (back to the liquid only regime, 1000° C., point 3) and transform the entire catalyst to a liquid again, where the carbon would be floated to the top.

This reactor design is elegant because the solids are made of the same two metals that are contained in the melt. The convenience is that the equilibrium can be shifted to either create or destroy particles by changing the temperature by only a relatively small amount to alter the location on the equilibrium phase diagram.

### Reactor Chemistry Example 2: Ni—Bi

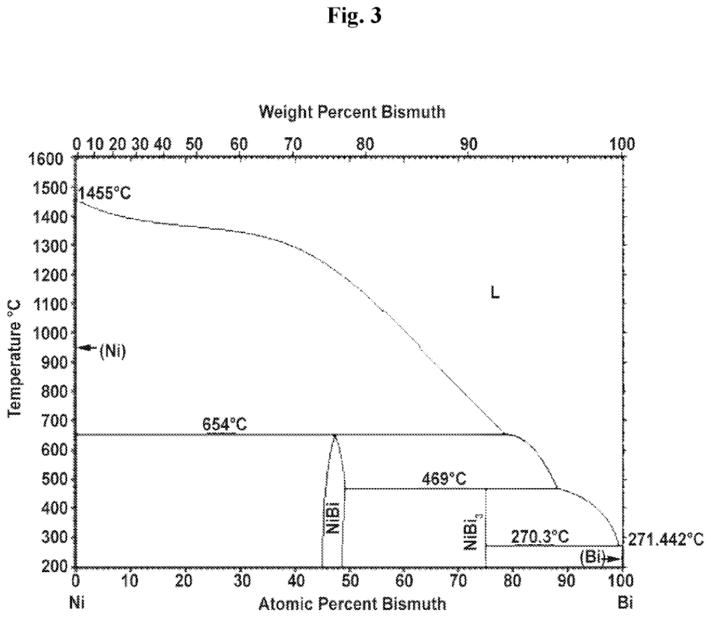

This reactor design is identical to the above, except for the fact that in this example, the phase diagram shows that the solid particles that are formed are pure Ni (and not a Ni—Bi alloy), since Bi does not alloy into Ni. The equilibrium phase diagrams for the Ni—Bi system are shown in FIG. 3.

### Reactor Geometry Example (FIG. 1)

The simplest reactor geometry requires the reactive gas (here CH₄) to be bubbled through a molten metal reactor where the entire reactor is kept at a temperature within the 2-phase region. In this region, a certain amount of solid phase (e.g., Ni, Ni₃Sn₂ etc.) will crystallize and will remain in equilibrium with the remaining molten liquid. The exact amount of solid vs. liquid in the two-phase reactor depends exactly where in the 2-phase region we are operating (i.e., “tie-line” analysis). The solid phases that form can crystallize either on the walls of the reactor and work their way inward as more solids form, or in the bulk of the melt seeded by an inert ceramic phase. The latter may occur because the interfaces, rather than the bulk, act as nucleation points for phase change (similar to how bubbles start forming on the walls of a pot when heated). Methane gas rises through the melt and can interact with the liquid (melt) phase and the solid phase in any of the positions detailed. Once the gas reaches the top of the reactor, it can pass through the solids and accumulated porous carbon floating on top of the melt and exit the reactor.

### Initial Results

In any catalytic system, the purpose of the catalyst is to lower the activation barrier for the reaction whereby increasing the rate of the reaction. Therefore, in many systems, the primary figure of merit is the apparent activation energy of the system (in reality, this is a measurement of the activation energy of the slowest step in a complex multi-step mechanism). Experimentally, one can measure the apparent activation energy by measuring the reaction rate as a function of temperature. One then fits this data to a so-called Arrhenius plot with 1/T on the x-axis and In (rate) on the y-axis. The slope of such a plot should yield a slope with the value of the activation energy for the reaction divided by R, the universal gas constant.

A purely Ni—Sn liquid melt gave an apparent activation energy of 355±9 KJ/mol (FIG. 2D)

Based on FIGS. 2A and 2B, we calculated the activation energy of solid Ni particles and solid Ni₃Sn₂ particles to be 67±5 KJ/mol and 162±3 kJ/mol, respectively. Importantly, the activation energy of phases such as Ni and Ni₃Sn₂ are highly dependent on geometry and size, therefore the activation energy calculated using particles of the above phases is only instructive to show that in general, their values are significantly lower than that of the liquid-only Ni—Sn system.

From FIG. 2D, we calculated the activation energy of the 2-phase melt (Ni—Sn liquid+Ni₃Sn₂ solids) at most 158±2 KJ/mol, which is less than the pure Ni—Sn melt, but more than the Ni₃Sn₂ particles, giving excellent evidence that the methane gas is interacting with the solid phase and that operating the reactor in the 2-phase region can enhance the rate of the pyrolysis reaction.

Due to the dramatic decrease in activation energy, the reactor which operated in the 2-phase region produced twice as much hydrogen (100 μmol H₂/min) compared to the reactor operating at the liquidus line (50 μmol H₂/min) at 1000° C.

Gas chromatography revealed that no CO was released, and that the level of CO₂ in the outlet was 800 ppm. Previous studies have shown that reduction of some metal oxide traces as the main reason for CO₂/CO formation, but do not report their concentration in the product stream (Patzschke et al., 2021; Li et al., 2011)

The active part of the reactor as shown in FIG. 1 inside the muffle furnace was 14 cm and was under the isothermal condition to within 0.5° C. (as measured by thermocouples placed at the bottom and top of the active region).

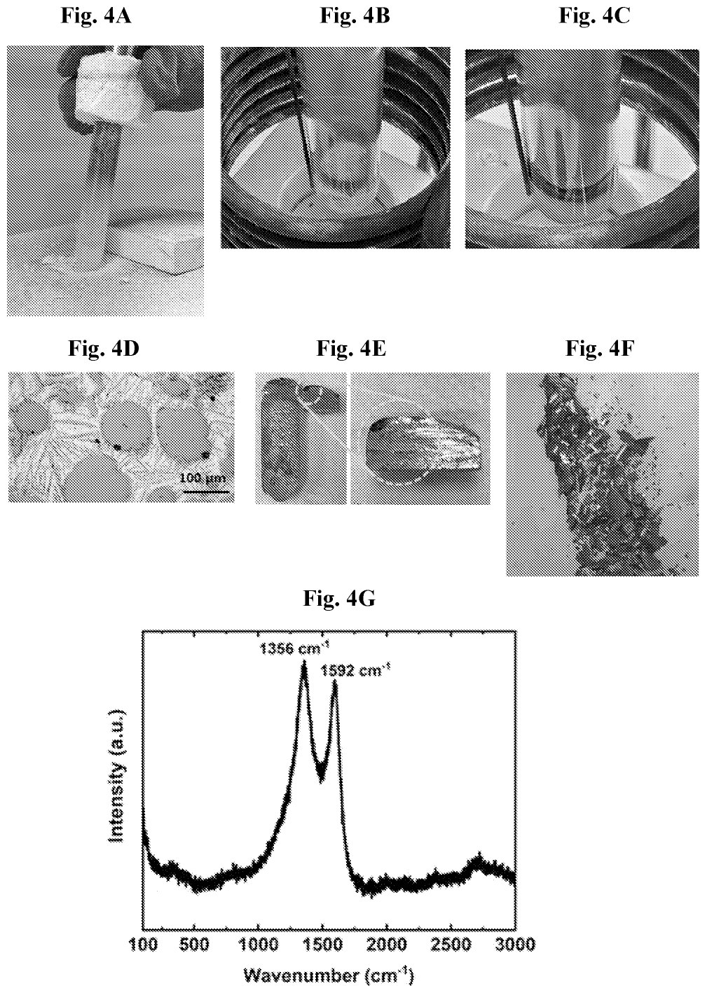

Interestingly the formation of the solid Ni₃Sn₂ phase was not spatially homogeneous throughout the volume of the reactor but rather separated into strata. FIG. 4A shows that the bottom stratum of the reactor is completely liquid, whereas strata above it contained the solid Ni₃Sn₂ phase together with the Sn—Ni liquid. To study the reason for this, an induction furnace was used to monitor the spatial distribution of solids in the Sn—Ni melt as the temperature was cooled from the all-liquid state (point 3) to the 2-phase region (point 2).

The spatial distribution of the solids was described by the crystallization of Ni₃Sn₂ starting at the upper surface of the melt at the interface with the walls of the reactor, forming a ring (FIG. 4B). As the melt is cooled deeper into the 2-phase region (e.g., forming more solids), the Ni₃Sn₂ started growing inwards at the top of the melt forming a disc (FIG. 4C). Finally, when the temperature was lowered to the final operational point well within the 2-phase region (point 2, FIG. 2C), the crystallization of Ni₃Sn₂ proceeded downwards into the melt forming the second strata above the all-liquid region observed in FIG. 4A.

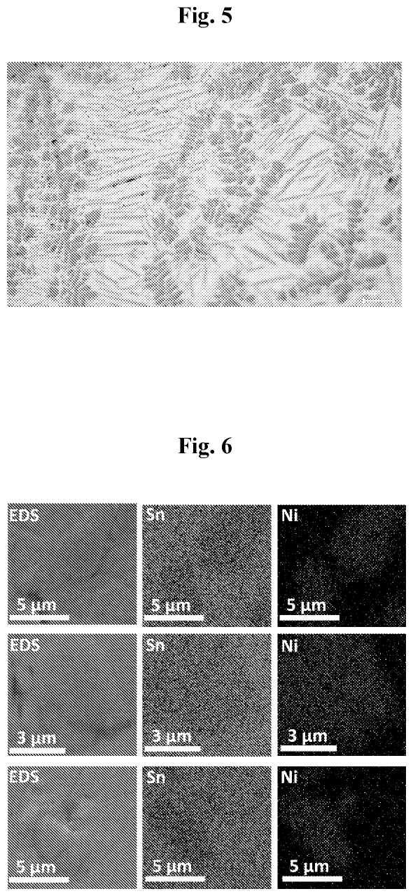

While thermodynamic information about the composition and number of phases can be derived from the phase diagrams, kinetic parameters such as the growth rate of the Ni₃Sn₂ solids, their size or their morphology cannot. Since the size and shape of the solid phase is critically important for this project, this information must be obtained experimentally. Continuous pyrolysis by bubbling 5% CH₄ in N₂ through the central tube at 100 sccm for 10 hours allowed for carbon accumulation from pyrolysis in the 2-phase reactor. Surprisingly, carbon accumulation was still able to accumulate at the top of the reactor despite the presence of the solid Ni₃Sn₂, likely due to the upward force of the bubbling gas. To better understand the structure of the Ni₃Sn₂ within the melt, once 10 h passed, the sample was quickly quenched (˜1 sec) in ice water and metallographic analysis was conducted on the molten reactor after 10 h of operation. This was performed by rapidly cooling the reactor by dropping it into a bucket of ice water below the oven, recovering the metal slug, and cutting the metal along its long axis, mounting the metal in an epoxy resin, and finishing with a grinding/polishing protocol appropriate for Sn—Ni alloys. The microscopic results for samples quenched from the point 2 and point 1 are shown in FIG. 4D and FIG. 5, respectively.

As can be seen from FIG. 4D, large circular particles approximately 100 microns in diameter are found in sample from location point 2 of the Ni—Sn phase diagram, where it is expected that there will be a solid Ni₃Sn₂ phase in equilibrium with a liquid. Indeed, EDX spectroscopy supports that these circular particles are Ni₃Sn₂ (FIG. 6). The rod-like solids in the micrograph are kinetic structures (i.e., not thermodynamic phases predicted on an equilibrium phase diagram) which formed in the few seconds required to quench from 1000° C. down to room temperature.

To confirm the non-equilibrium structures, similar quenching and preparation method was applied for the reactor operating at the liquidus line point 1. FIG. 5 is a microscopic image of this sample, wherein the circular Ni₃Sn₂ structures are not present, but the elongated kinetic structures are.

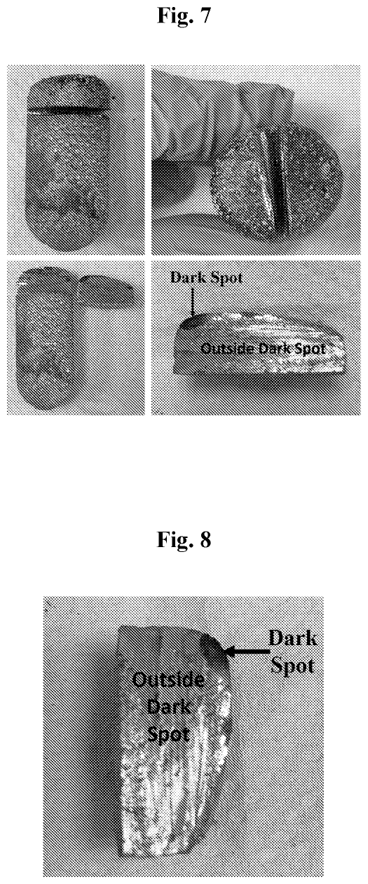

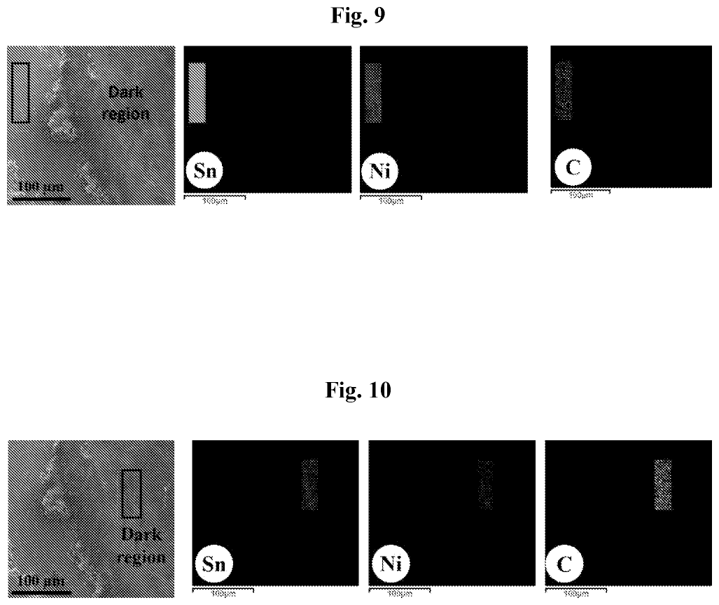

FIG. 4E, FIG. 7 and FIG. 8 show a cross-section of the recovered molten catalyst after 10 hours of operation in the 2-phase region and rapid quenching. The dark spots in the upper left part of the melt are confirmed by EDX to be rich in carbon (FIGS. 9-10, Table 1). It is likely that this carbon accumulated on the solid Ni₃Sn₂ phase since they are co-located at the same position within the reactor. The accumulation of carbon on the solid Ni₃Sn₂ is expected; this both confirms the interaction with the gas bubbles with the 2-phase region and explains the dramatic decrease in the apparent activation energy when the solids are present in the melt.

TABLE 1
SEM-EDS results of the quenched metal chunk as shown in FIG. 8

| | |
|---|---|
| Outside dark spot | Inside dark spot |

| Element | Atomic percent | Element | Atomic percent |
|---|---|---|---|
| C | 18.79 | C | 71.98 |
| Ni | 27.47 | Ni | 9.37 |
| Sn | 53.74 | Sn | 18.65 |

One of the many unique features of this reactor, unlike other solid catalysts where removing coke, requires gasification of the accumulated carbon, or for the catalyst to be replaced entirely, cleaning and recovery of the solid catalyst after coking herein is both simple and does not require to stop the primary pyrolysis reaction.

Here, the multi-phase reactor need only be heated above the liquidus line (point 3, FIG. 2C), at which point the solid Ni₃Sn₂ will dissolve into the Sn—Ni liquid melt, the carbon will be released to the top of the reactor with the rest of the carbon. Afterwards, the reactor can be cooled back into the 2-phase region (point 2, FIG. 2C) where fresh Ni₃Sn₂ catalyst will be formed in the same manner as described by FIG. 4B and FIG. 4C. This cycle, illustrated by the circular arrows in FIG. 2C, allows for continuous cleaning and recovery whilst never stopping the production of hydrogen. Indeed, cycling the reactor to 1200° C. (point 3, FIG. 2C) for 1 h (after 10 h at point 2, FIG. 2C) was enough to release the carbon bound to the solids (FIG. 4E) and reform fresh carbon-free Ni₃Sn₂ phases.

The carbon product obtained owing to the operating temperature of the reactor was recovered and found to be partially graphitic in nature (FIG. 4F).

Raman spectroscopy (FIG. 4G) on the recovered carbon shows the presence of characteristic G band at 1592 cm⁻¹, confirming the graphitic nature of the accumulated carbon atop the melt and the band at 1356 cm⁻¹ associated with defective structures and disorder (Sorcar et al., 2018; Pimenta et al., 2007). The accumulated carbon did not contain single-walled carbon nanotubes as no band around 200 cm⁻¹ was observed (Saito et al., 1994; Müller et al., 1997).

### REFERENCES

Catalan, L. J. J.; Rezaei, E., Coupled hydrodynamic and kinetic model of liquid metal bubble reactor for hydrogen production by noncatalytic thermal decomposition of methane, International Journal of Hydrogen Energy, 2020, 45, 2486-2503
Kang, D.; Rahimi, N.; Gordon, M. J.; Metiu, H.; McFarland, E. W., Catalytic methane pyrolysis in molten MnCl₂—KCl, Applied Catalysis B: Environmental, 2019, 254, 659-666
Kang, D.; Palmer, C.; Mannini, D.; Rahimi, N.; Gordon, M. J., Metiu, H.; McFarland, E. W., Catalytic methane pyrolysis in molten alkali chloride salts containing iron, ACS Catalysis, 2020, 10, 7032-7042
Khan, M.; Crynes, B. L., Survey of recent methane pyrolysis literature, Industrial & Engineering Chemistry, 1970, 62, 54-59
Li, Y.; Li, D.; Wang, G., Methane decomposition to COₓ-free hydrogen and nano-carbon material on group 8-10 base metal catalysts: A review, Catalysis Today, 2011, 162, 1-48
Müller, T. E.; Reid, D. G.; Hsu, W. K.; Hare, J. P.; Kroto, H. W.; Walton, D. R. M., Synthesis of nanotubes via catalytic pyrolysis of acetylene: A SEM study, Carbon, 1997, 35, 951-966
Muradov, N.; Veziroğlu, T., From hydrocarbon to hydrogen-carbon to hydrogen economy, International Journal of Hydrogen Energy, 2005, 30, 225-237
Muradov, N., Low to near-zero CO₂ production of hydrogen from fossil fuels: Status and perspectives, International Journal of Hydrogen Energy, 2017, 42, 14058-14088
Palmer, C.; Tarazkar, M.; Kristoffersen, H. H.; Gelinas, J.; Gordon, M. J.; McFarland, E. W.; Metiu, H., Methane pyrolysis with a molten Cu—Bi alloy catalyst, ACS Catalysis, 2019, 9, 8337-8345
Parkinson, B.; Matthews, J. W.; McConnaughy, T. B.; Upham, D.C.; McFarland, E. W., Techno-economic analysis of methane pyrolysis in molten metals: decarbonizing natural gas, Chemical Engineering & Technology, 2017, 40, 1022-1030
Patzschke, C. F.; Parkinson, B.; Willis, J. J.; Nandi, P.; Love, A. M.; Raman, S.; Hellgardt, K., Co—Mn catalysts for H₂ production via methane pyrolysis in molten salts, Chemical Engineering Journal, 2021, 414, 128730
Pimenta, M. A.; Dresselhaus, G.; Dresselhaus M. S.; Cancado, L. G.; Jorio, A.; Saito, R., Studying disorder in graphite-based systems by Raman spectroscopy, Physical Chemistry Chemical Physics, 2007, 9, 1276-1290
Popov, M.; Shinkarev, V.; Brezgin, P.; Solov'ev, E.; Kuvshinov, G., Effect of pressure on the production of hydrogen and nanofilamentous carbon by the catalytic pyrolysis of methane on Ni-containing catalysts, Kinetics and catalysis, 2013, 54, 481-486
Saito, Y.; Okuda, M.; Yoshikawa, T.; Bandow, S.; Yamamuro, S.; Wakoh, K.; Sumiyama, K.; Suzuki, K., Synthesis of Sc₁₅C₁₉ crystallites encapsulated in carbon nanocapsules by Arc evaporation of Sc—C composite, Japan Journal of Applied Physics, 1994, 33, L186
Schmetterer, C.; Flandorfer, H.; Richter, K. W.; Saeed, u.; Kauffman, m.; Roussel, P.; Ipser, H., A new investigation of the system Ni—Sn, Intermetallics, 2007, 15, 869-884
Serrano, D.; Botas, J.; Guil-Lopez, R., H₂ production from methane pyrolysis over commercial carbon catalysts: kinetic and deactivation study, International Journal of Hydrogen Energy, 2009, 34, 4488-4494
Sorcar, S.; Thompson, J.; Hwang, Y.; Park Y. H.; Majima, T.; Grimes, C. A.; Durrant, J.; In, S-I., High-rate solar-light photoconversion of CO₂ to fuel: Controllable transformation from C₁ to C₂ products, Energy & Environmental Science, 2018, 11, 3183-3193
Steinberg, M., Fossil fuel decarbonization technology for mitigating global warming, International Journal of Hydrogen Energy, 1999, 24, 771-777
Sun, Q.; Tang, Y.; Gavalas, G. R., Methane pyrolysis in a hot filament reactor, Energy & fuels, 2000, 14, 490-494
Upham, D. C.; Agarwal, V.; Khechfe, A.; Snodgrass, Z. R.; Gordon, M. J.; Metiu, H.; McFarland, E. W., Catalytic molten metals for the direct conversion of methane to hydrogen and separable carbon, Science, 2017, 358, 917-921
Zhang, J.; Li, X.; Xie, W.; Hao, Q.; Chen, H.; Ma, X., K₂CO₃-promoted methane pyrolysis on nickel/coal-char hybrids, Journal of Analytical and Applied Pyrolysis, 2018, 136, 53-61

1. A process for generating hydrogen from a hydrocarbon, comprising interacting said hydrocarbon with a metal catalyst comprising a mixture of at least two metals, under conditions, including temperature, at which a solid phase of at least one of said metals and a liquid phase of said metal catalyst (molten metal) are simultaneously present, to thereby obtain said hydrogen.

2. The process of claim 1, wherein both the release rate of the hydrogen generated and the temperature, during said process, are monitored, and said temperature is increased or decreased, when necessary, within a range at which both said solid phase and said liquid phase are simultaneously present, to thereby increase or decrease the ratio between said liquid phase and said solid phase accordingly, and consequently increase the amount of hydrogen generated.

3. The process of claim 2, wherein the hydrogen release rate is below a predefined level, indicating carbon accumulation on said solid phase and consequently a functioning level of said catalyst that is lower than a predefined level, and said temperature is increased thereby increasing said hydrogen release rate.

4. The process of claim 2, wherein the temperature is approaching a predefined level at which said liquid phase only is present, and said temperature is decreased thereby increasing the amount of hydrogen generated.

5. The process of claim 1, wherein:
(i) said metal catalyst comprises a first metal selected from the group consisting of platinum (Pt), palladium (Pd), nickel (Ni), copper (Cu), and a mixture thereof, and a second metal selected from the group consisting of indium (In), bismuth (Bi), gallium (Ga), tin (Sn), lead (Pb), and a mixture thereof; or
(ii) said process is carried out within a temperature range at which the percentage of said metal catalyst existing in its solid form is from 1% to 99%.

6. (canceled)

7. The process of claim 1, wherein:
(i) said metal catalyst comprises a mixture of Ni and Sn; and exists both as solid Ni₃Sn₂ and as molten Ni and Sn mixture; or
(ii) said metal catalyst comprises a mixture of Ni and Big and exists both as solid Ni and as molten Ni and Bi mixture.

8. The process of claim 7, wherein;
(i) said metal catalyst comprises a mixture of Ni and Sn; and said process is carried out at a temperature range of from about 900° C. to about 1300° C.; or
(ii) said metal catalyst comprises a mixture of Ni and Bi; and said process is carried out at a temperature range of from about 850° C. to about 1600° C.

9-10. (canceled)

11. The process of claim 1, wherein said process is carried out in the presence of an inert ceramic material.

12. The process of claim 1, wherein:
(i) said process is for a natural gas pyrolysis, and comprises interacting said natural gas with said metal catalyst to thereby obtain said hydrogen and solid carbon; or
(ii) said process is for reforming of said hydrocarbon, and comprises (a) interacting said hydrocarbon together with carbon dioxide, with said metal catalyst, to thereby obtain said hydrogen and carbon monoxide; or (b) interacting said hydrocarbon together with steam, with said metal catalyst, to thereby obtain said hydrogen and carbon dioxide; or interacting said hydrocarbon together with both carbon dioxide and steam, with said metal catalyst, to thereby obtain said hydrogen and carbon monoxide.

13. The process of claim 12, wherein said natural gas and said hydrocarbon each is methane.

14. The process of claim 12, wherein:
(i) said metal catalyst comprises a mixture of Ni and Sn, and exists both as solid Ni₃Sn₂ and as molten Ni and Sn mixture; and said process is carried out at a temperature range of from about 900° C. to about 1300° C.; or
(ii) said metal catalyst comprises a mixture of Ni and Bi; and exists both as Ni particles and as molten Ni and Bi mixture; and said process is carried out at a temperature range of from about 850° C. to about 1600° C.

15-17. (canceled)

18. The process of claim 1, wherein said process is carried out in a system, comprising:
(a) a reaction chamber comprising an inlet for introducing said hydrocarbon, an outlet for releasing said hydrogen, at least one temperature sensor, and at least one heater; and
(b) a receiver configured to receive data from said at least one temperature sensor,
wherein activation and deactivation of said at least one heater is determined based on said received data.

19. The process of claim 18, wherein said reaction chamber further comprises an outlet for removing solid carbon obtained during said process.

20. The process of claim 18, wherein;
(i) said receiver is a computing system comprising a processor and a memory, and said computing system is configured to receive data from said at least one temperature sensor and analyze same in real-time to determine the temperature within the reaction chamber and activate/deactivate said at least one heater accordingly: or
(ii) said reaction chamber further comprises a hydrogen sensor located at said outlet for releasing said hydrogen.

21. (canceled)

22. The process of claim 20, wherein said reaction chamber comprises a hydrogen sensor located at said outlet for releasing said hydrogen; said receiver is a computing system comprising a processor and a memory; and said computing system is configured to receive data from: (1) said at least one temperature sensor and analyze same in real-time to determine the temperature within the reaction chamber and activate/deactivate said at least one heater accordingly; and (2) said hydrogen sensor and analyze same in real-time to determine the release rate of the hydrogen generated and activate said at least one heater in case said release rate is below a predetermined level.

23. The process of claim 18, wherein said reaction chamber comprises more than one temperature sensor each located at a different location within said reaction chamber, and more than one heater each located at a different location within said reaction chamber, enabling to maintain, during said process, a different temperature range in each one of said locations.

24. The process of claim 23, wherein:
(i) the temperature in the lower part of said reaction chamber, during said process, is higher than that in the upper part of said reaction chamber, such that the percentage of said metal catalyst existing in its liquid form in the lower part of said reaction chamber is higher than that in the upper part of said reaction chamber;
(ii) the temperature in the upper part of said reaction chamber, during said process, is higher than that in the lower part of said reaction chamber, such that the percentage of said metal catalyst existing in its liquid form in the upper part of said reaction chamber is higher than that in the lower part of said reaction chamber.

25. The process of claim 24, wherein:
(i) the temperature in the lower part of said reaction chamber, during said process, is higher than that in the upper part of said reaction chamber; and the metal catalyst in the lower part of said reaction chamber exists in its liquid form only; or
(ii) the temperature in the upper part of said reaction chamber, during said process, is higher than that in the lower part of said reaction chamber; and the metal catalyst in the upper part of said reaction chamber exists in its liquid form only.

26-27. (canceled)

28. A system for generating hydrogen from a hydrocarbon, comprising:
(a) a reaction chamber comprising an inlet for introducing said hydrocarbon, an outlet for releasing said hydrogen, at least one temperature sensor, at least one heater, and optionally an outlet for removing solid carbon obtained during said process; and
(b) a receiver configured to receive data from said at least one temperature sensor,
wherein activation and deactivation of said at least one heater is determined based on said received data.

29. (canceled)

30. The system of claim 28, wherein said receiver is a computing system comprising a processor and a memory that is configured to receive said data and analyze same in real-time to determine the temperature within the reaction chamber and automatically activate/deactivate said at least one heater accordingly.

31. The system of claim 28, wherein said reaction chamber further comprises a hydrogen sensor located at said outlet for releasing said hydrogen.

32. The system of claim 31, wherein said receive is a computing system comprising a processor and a memory that is configured to receive said data and analyze same in real-time to determine both: (a) the temperature within the reaction chamber and automatically activate/deactivate said at least one heater accordingly; and (b) the release rate of the hydrogen generated and activate said at least one heater in case said release rate is below a predetermined level.

33. The system of claim 30, wherein;
(i) said computing system is an integral part of said reaction chamber or is wirely connected thereto, and wherein said computing system optionally also comprises a display: or
(ii) said computing system is a remote computing system that is wirelessly associated with said reaction chamber.

34. The system of claim 32, wherein;
(i) said computing system is an integral part of said reaction chamber or is wirely connected thereto, and wherein said computing system optionally also comprises a display; or
(ii) said computing system is a remote computing system that is wirelessly associated with said reaction chamber.

35. The process of claim 11, wherein said inert ceramic material is selected from the group consisting of silica, alumina, ceria, and lanthana.
